(19) United States
(12) Patent Application Publication
(10) Pub. No.: US 2002/0045706 A1
(43) Pub. Date: Apr. 18, 2002

(54) Biomedical molding materials from semi-solid precursors

(76) Inventors: Michael R. Houston, Eagle River, WI (US); David S. Soane, Piedmont, CA (US)

Correspondence Address: Jacqueline S. Larson, P.O. Box 2426, Santa Clara, CA, 95055-2426, US

(21) Appl. No.: 09/894,861

(22) Filed: Jun. 27, 2001

Related U.S. Application Data
(63) Continuation-in-part of application No. 09/511,661, filed on Feb. 22, 2000.
Application No. 09/511,661 is a continuation-in-part of application No. PCT/US99/22048, filed on Sep. 22, 1999.
(60) Provisional application No. 60/101,285, filed on Sep. 22, 1998.

(51) Int. Cl. C08F 8/00; C08L 83/00; C08F 2/00

(52) U.S. Cl. 525/100; 525/242

(57) ABSTRACT

The present invention relates to a process for the production of polymeric moldings, such as medical device moldings and optical and ophthalmic lenses, preferably contact lenses and intraocular lenses. The invention also relates to a polymeric precursor mixture useful in polymeric moldings and also to methods of making the using the polymer and moldings.

### CROSS REFERENCES TO RELATED APPLICATIONS

This application is a continuation-in-part of copending application Ser. No. 09/511,661, filed Feb. 22, 2000, which is a continuation-in-part of International patent application No. PCT/US99/22048, filed Sep. 22, 1999 and designating the United States, which claims the benefit of U.S. provisional application Ser. No. 60/101,285, filed Sep. 22, 1998; the disclosures of all of which are incorporated herein by reference in their entireties.

### FIELD OF THE INVENTION

The present invention relates to a process for the production of polymeric moldings, such as medical device moldings and optical and ophthalmic lenses, preferably contact lenses and intraocular lenses. The invention also relates to a polymeric precursor mixture useful in the production of polymeric moldings and also to methods of making and using the polymeric precursor mixtures and moldings.

### SUMMARY OF THE INVENTION

The invention relates to a process for the production of moldings, in particular medical device moldings, more particularly optical lens moldings and ophthalmic lens moldings. Preferred moldings are contact lenses and intraocular lenses. Examples of other applicable moldings are biomedical moldings such as bandages or wound closure devices, heart valves, coronary stents, artificial tissues and organs, and films and membranes. The process makes use of a novel semi-solid precursor mixture that is shaped between two mold halves, cured, and released from the mold to produce the moldings of interest. Other aspects of the invention relate to the semi-solid precursor mixtures used in the process of this invention, as well as to the moldings so produced. These aspects of the invention and several presently preferred embodiments will be described in more detail below.

More particularly, the invention in one aspect is directed to a polymeric precursor mixture which comprises a first component selected from one or more of the group consisting of prepolymers and dead polymers; and optionally, a second component selected from one or more of the group consisting of reactive plasticizers and non-reactive diluents; provided that at least one reactive plasticizer is present when a prepolymer is not present.

In another aspect, the invention relates to a novel process in which a semi-solid precursor material is constituted, shaped by taking on the dimensions defined by the cavity between two or more molds, cured by a source of polymerizing energy, and released from the mold to produce the moldings of interest. An advantage of the novel process of the present invention is the speed with which the semi-solid precursor mixture can be cured. As will be discussed in more detail below, the overall concentration of reactive species is quite low in the semi-solid precursor mixture. Thus, the desired degree of reaction can be achieved very quickly using appropriate reaction initiators and a source of polymerizing energy.

Thus, the invention is directed to a method for preparing a molding comprising (a) mixing together an initiator and a polymeric precursor mixture comprising a first component selected from one or more of the group consisting of prepolymers and dead polymers; and optionally, a second component selected from one or more of the group consisting of reactive plasticizers and non-reactive diluents; provided that at least one reactive plasticizer is present when a prepolymer is not present; to form a semi-solid composition; (b) providing a mold corresponding to a desired geometry; introducing said semi-solid composition into said mold; (c) compressing said mold so that the semi-solid composition takes on the shape of the internal cavity of said mold; and exposing said semi-solid composition to a source of polymerizing energy;to give a cured molding.

By “quick curing time” is meant that the semi-solid precursor mixturescure faster than a liquid composition in cases where the liquid formulation possesses the same type of reactive functional groups and the other curing parameters such as energy intensity and part geometry are constant. Typically, about 10 minutes or less of exposure to a source of polymerizing energy is needed in order to achieve the desired degree of cure when photoinitiated systems are used. More preferably, the curing occurs in less than about 100 seconds of exposure, and even more preferably in less than about 10 seconds. Most preferably, the curing occurs in less than about 2 seconds of exposure to a source of polymerizing energy. Such rapid curing times can be more easily realized for thin moldings such as contact lenses.

In one embodiment of this invention, the semi-solid precursor mixture comprises a prepolymer containing polymerizable groups, and optionally a non-reactive diluent. Upon curing, the prepolymer forms crosslinking bonds to create a polymer network. In this case, reaction need only proceed to the extent necessary to impart the desired mechanical properties to the final gel, which are generally a strong function of crosslink density. When a water-soluble, semi-solid prepolymer mixture is used, reaction must also be sufficient to render the resultant gel water-insoluble if the molding is to be used in an aqueous environment. Thus, since little overall reaction is needed when using a semi-solid precursor mixture, the curing step can be completed quickly and efficiently. Additionally, since there are no small-molecule, monomeric species present in this particular embodiment, there is no concern regarding unreacted monomers at the end of cure unlike with conventional polymerization schemes, further promoting short curing times versus the current state of the art practices.

Another advantage of the presently disclosed process is that when free radical-based polymerization schemes are used to cure the semi-solid precursor mixtures, inhibition effects due to oxygen are reduced. While not wishing to be bound by theory, it is believed that this effect results from a low oxygen mobility within the semi-solid material prior to and during cure, as compared to conventional liquid-based casting systems. Thus, complex and costly schemes (both molding of the molds as well as molding of the final part, as described in U.S. Pat. Nos. 5,922,249 and 5,753,150, for instance) currently used to exclude oxygen from molding processes can be eliminated, and reaction will still proceed to completion in a timely fashion as mentioned above.

Yet another advantage of the presently disclosed process is that conventional liquid handling problems during mold filling, such as evaporative rings, inclusion of bubbles or voids, and Schlieren effects, can be avoided with the use of the semi-solid precursor mixture. Furthermore, concerns are relaxed regarding compatibility of the mixture with mold materials because semi-solid materials typically do not act rapidly to attack or solvate materials with which they come into contact, such as upon placement into the mold. These advantages can be attributed to the nature of semi-solid materials in general, in that the materials possess little solvating power even when small molecule species are present. While not wishing to be bound by theory, it is believed that this effect is due to an affinity for the semi-solid matrix of any small molecule species present, which inhibits or at least delays the migration of small molecules out of the semi-solid material, thus delaying or preventing both evaporation effects and attack of an adjacent material such as the mold material.

Thus, a wide array of suitable mold materials may be used to shape the moldings of interest in accordance with the present invention. Appropriate mold materials may include quartz, glass, sapphire, and various metals. Suitable mold materials may also include any thermoplastic material that can be molded to an optical quality surface and with mechanical properties which allow the mold to maintain its critical dimensions under process conditions employed in the process disclosed herein. Examples of suitable thermoplastic materials include polyolefins such as low, medium, and high-density polyethylene; polypropylene and copolymers thereof; poly-4-methylpentene; polystyrene; polycarbonate; polyacetal resins; polyacrylethers; polyarylether sulfones; nylons such as nylon 6, nylon 11, or nylon 66; polyesters; and various fluorinated polymers such as fluorinated ethylene propylene copolymers.

Because the semi-solid materials do not readily attack the mold materials used for lens production, a great processing advantage can be realized in the recycling or reuse of lens molds after each molding cycle. Such reuse is facilitated by the minimal interactions between the semi-solid materials and the mold materials during the normal course of processing, which is further aided by the rapid curing made possible by the novel features of the semi-solid precursor material. Thus, in one embodiment the present invention discloses a process in which contact lens molds are reused for more than one molding cycle, with optional cleaning steps in between uses, in accordance with the use of semi-solid precursor mixtures as discussed herein.

The invention also relates to novel semi-solid precursor mixtures which can be employed to manufacture the moldings of interest. The precursor mixture comprises polymerizable groups that form polymer chains or polymer networks upon cure. Polymerization mechanisms that may be mentioned here purely by way of example include free-radical polymerization, cationic or anionic polymerization, cycloaddition, Diels-Alder reactions, ring-opening-metathesis polymerization, and vulcanization. Polymerizable groups may be incorporated into the semi-solid precursor mixture in the form of monomers, oligomers, as pendant reactive groups along a polymeric backbone, or in the form of an otherwise reactive monomeric, oligomeric, or polymeric component. Oligomers or polymers possessing reactive groups, or being otherwise reactive, shall hereinafter be referred to as “prepolymers”. For the purposes of this disclosure, prepolymers shall furthermore refer to molecules having a formula weight greater than 300, or molecules which comprise more than one repeat unit linked together. Functionalized molecules having a formula weight below 300 and comprising only one repeat unit shall be referred to as reactive plasticizers, as discussed below. The prepolymers may possess terminal and/or pendant reactive functionalities, or they may simply be prone to grafting or other reactions in the presence of the polymerizing system used to constitute the semi-solid precursor mixture.

The semi-solid precursor mixture may furthermore comprise non-reactive or substantially non-reactive polymers, which shall hereinafter be referred to as “dead polymers”. The dead polymers may serve to add bulk to the semi-solid precursor mixture without adding a substantial amount of reactive groups, or the dead polymers may be chosen to impart various chemical, physical, and/or mechanical properties to the moldings of interest. The dead polymers may further be used to impart a desired degree of semi-solid consistency to the semi-solid precursor mixture.

Alternatively, small molecule reactive species (i.e., monomers having a formula weight below about 300) may be added to the oligomers, prepolymers, and/or dead polymers of the semi-solid precursor mixture in order to impart an added degree of reactivity and/or to achieve the desired semi-solid consistency and compatibility, in which case the small molecule reactive species may serve to plasticize the polymeric components. The small molecule species may otherwise serve as polymerization extenders, accelerators, or terminators during reaction. Regardless of their ultimate effect upon the semi-solid precursor mixture and the subsequent polymerization reaction, such components shall hereinafter be referred to as “reactive plasticizers”.

In addition, the semi-solid precursor mixture may comprise non-reactive or substantially non-reactive diluents. The diluents may serve as bulking agents that do not contribute to the reactivity of the system, or they may function as compatibilizers in order to reduce phase separation tendencies of the other components in the mixture. While the diluents may play some role in the polymerization process, they will typically be assumed to be non-reactive and not contribute significantly to the polymer chains or networks formed upon polymerization.

In total, the semi-solid precursor mixture shall contain one or more components selected from the group consisting of reactive plasticizers/monomers, oligomers, and prepolymers. Dead polymers and diluents may optionally be added for the reasons mentioned above. The components are chosen and the composition adjusted accordingly to achieve the desired semi-solid consistency of the precursor mixture, the desired degree of reactivity (including effects on cure time and shrinkage), as well as the final physical and chemical properties of the moldings so produced.

By “semi-solid” is meant that the mixture is deformable, yet can be handled as a discrete, free-standing entity during short operations such as insertion into a mold. For pure polymeric systems, the modulus of elasticity of a pure polymeric material is roughly constant with respect to molecular weight, above a certain value, known as the molecular weight cutoff. Thus, for the purpose of this disclosure, and in one aspect of the present invention, semi-solids shall be defined as materials that, at fixed conditions such as temperature and pressure, exhibit a modulus below the constant modulus value seen for a given pure polymeric system at high molecular weights, i.e., above the molecular weight cutoff. The decrease in modulus used to achieve a semi-solid consistency may be achieved by incorporation of plasticizers (reactive or non-reactive diluents) into the semi-solid precursor mixture that serve to plasticize one or more of the prepolymer or dead polymer components. Alternatively, low molecular weight analogs below the molecular weight cutoff for a given polymer (either prepolymer or dead polymer) may be used in place of the fully polymerized version to achieve a reduction in modulus at the processing temperature.

In practice, semi-solids referred to herein generally have a modulus of elasticity that is lower than about 10¹⁰-10¹¹ dynes/cm². The decreased modulus of the semi-solid at a given temperature, whether achieved by reduction of the polymer molecular weight (prepolymer or dead polymer) or by the addition of reactive or non-reactive plasticizers, provides desirable processing and final molding properties, as already discussed and further discussed below.

In the event that the semi-solid precursor mixtures are cooled in order to achieve the desired semi-solid consistency, one or more components of the semi-solid precursor mixture may become frozen. See, for example, U.S. Pat. No. 6,106,746. For the purpose of this disclosure, and in another aspect of the present invention, semi-solids shall therefore be further defined as materials that exhibit a modulus below the modulus of any of the said frozen components, as measured in their pure component, frozen state. By way of example, if water were one of the components used in the semi-solid precursor mixture and if a desired processing temperature were below 0° C. (the freezing point of pure water), then the mixture would be considered a semi-solid so long as its modulus remained below that of pure, frozen water at the processing temperature used. Thus, the semi-solids of the present invention may be differentiated from traditionally frozen materials because the modulus of the semi-solid material shall remain lower than the modulus of the pure component materials exhibiting freezing point temperatures above the desired processing temperature. Such a modulus reduction is advantageous because it allows for a more facile deformation of the material when the mold halves are brought together to define the internal mold cavity and molding shape. Furthermore, by judicious choice of the semi-solid precursor composition, a desired semi-solid consistency can generally be achieved at or near room temperature, thus eliminating the need for substantial cooling in order to realize the advantages of solid handling, as well as the need for substantial heating in order to realize the advantages of liquid handling.

With respect to liquids, semi-solids are differentiated in that they may be handled as discrete, free-standing quantities over time periods necessary for at least the shortest processing operation. Insertion into a mold assembly, for example, may require that the semi-solid be handled for about 1 second in order to retrieve a discrete quantity of semi-solid material and place it into one half of an open mold. For this purpose, the semi-solid may exist in the shape of a preform, where the semi-solid has undergone some previous shaping operation, during and/or after which conditions may be adjusted to achieve a semi-solid consistency. Alternatively, the semi-solid may be pumped from a reservoir into the mold cavity, so long as the conditions are such that there is no need for gasketing or other mold enclosure to keep the material from flowing out of the mold prematurely. By contrast, liquids cannot be handled as discrete, free-standing quantities without unwanted flow and deformation for even the shortest processing steps. Mold cavities sealed with gaskets or upright mold cavities where the concave mold half faces up must be used in order to keep liquid precursor mixtures from exiting the mold prematurely. This requirement is overcome by the present invention with the disclosure of the unique semi-solid precursor mixtures that do not flow undesirably during short processing operations such as mold filling.

Temperature will have a strong effect on the flowability of the semi-solid materials of this invention since such materials will soften appreciably upon heating. The fact that semi-solids may behave like liquids upon sufficient heating does not preclude their novel use in the practice of the current invention so long as the materials exist as a semi-solid during at least some portion of the molding process. In practice it has been observed that materials displaying the desired semi-solid consistency typically exhibit a viscosity of about 50,000 centipoise or greater. Likewise, such materials have been found to exhibit a dynamic modulus of approximately at least 10⁵-10⁶ dynes/cm² or greater. These numbers are not intended to provide absolute minimums for semi-solid behavior, but rather have been found in practice to indicate the approximate ranges where semi-solid behavior begins.

One advantage of the semi-solid precursor mixtures of the present invention is the low shrinkage which can be realized upon curing. By way of example, if one were to consider the shrinkage of pure methyl methacrylate monomer upon cure, the amount of shrinkage as given by density change upon cure is approximately 25-30% (specific gravity of MMA monomer equals ˜0.939, and of PMMA equals ˜1.19). This shrinkage results from curing the monomer, which has a methacrylate molar concentration of about 9.3 M (M=moles/liter). Larger molecular-weight monomeric species exist, up to and including oligomers, that have reduced methacrylate concentrations down to about 2-5 M, enabling shrinkages as low as about 7-15% upon cure. The advantage of using semi-solid precursor mixtures in the practice of the present invention is that the methacrylate group concentration (or other reactive functionality, e.g. acrylate, acrylamide, methacrylamide, vinyl, vinyl ether, allyl, etc.) can be reduced below even the 2-5 M level seen for large monomers and oligomers, which have traditionally been limited by the requirement of exhibiting a relatively low viscosity, i.e., low enough to be processed as a liquid. So, for example, when a prepolymer is modified to possess methacrylate functional groups on 1% of its backbone units, the methacrylate concentration drops to about 0.1 M, leading to a shrinkage upon cure of approximately 0.3%. (The shrinkage in this example system may be lower in practice because the amount of shrinkage per methacrylate qualitatively decreases with increasing monomer size.) Such low functional group concentrations have not been utilized by prior art methodologies due to the unnecessary requirement of low, liquid-like viscosities, which limited the size of the reactive molecules that could be used for formulation purposes, thus leading to high inherent shrinkages upon cure.

When the prepolymer is diluted with dead polymers and/or inert plasticizers, then the overall methacrylate concentration is decreased even further, along with the resulting shrinkage of the semi-solid precursor mixture upon cure. Alternatively, dead polymers can be mixed with reactive plasticizers, and optionally prepolymers and non-reactive diluents, to give semi-solid precursor mixtures exhibiting functional group concentrations below about 2 M and shrinkage upon cure of less than about 5%. This can be reasoned by considering if a monomer exhibits a shrinkage of 15% upon cure, and is only present at 30 wt % in the semi-solid precursor mixture, with the balance being dead polymers and/or non-reactive diluents, then the expected shrinkage of the semi-solid precursor mixture upon cure will be approximately 4.5%. Thus, for the purposes of this disclosure, by “low shrinkage” is meant that at least one of two conditions is met: (1) the amount of shrinkage as measured by density change before and after curing is 5% or less; or (2) the concentration of reactive groups prior to cure is less than 2M. By specifically embracing the semi-solid consistency of the precursor mixtures disclosed by this invention (as opposed to conventional liquid systems), a wide array of processing and formulation advantages are made possible, as discussed in detail throughout this specification.

The semi-solid precursor mixtures disclosed by the present invention may be advantageously utilized to produce polymerized and/or crosslinked moldings. Therefore, in yet another aspect, the present invention relates to moldings produced from curing a semi-solid precursor mixture. For the purpose of producing contact lenses or intraocular lenses, the compositions of the moldings are chosen such that they become hydrogels when placed into essentially aqueous solutions; that is, the moldings will absorb about 10 to 90 wt % water upon establishing equilibrium in a pure aqueous environment, but will not dissolve in the aqueous solution. Said moldings shall be hereinafter referred to as “gels”.

For the purposes of this disclosure, essentially aqueous solutions shall include solutions containing water as the majority component, and in particular aqueous salt solutions. It is understood that certain physiological salt solutions, i.e., saline solutions, may be preferably used to equilibrate or store the moldings in place of pure water. In particular, preferred aqueous salt solutions have an osmolarity of from about 200 to 450 milli-osmolarity in one liter; more preferred solutions are from about 250 to 350 milliosmol/L. The aqueous salt solutions are advantageously solutions of physiologically acceptable salts such as phosphate salts, which are well-known in the field of contact lens care. Such solutions may further comprise isotonicizing agents such as sodium chloride, which are again well known in the field of contact lens care. Such solutions shall hereinafter be referred to generally as saline solutions, with no preference given to salt concentrations and compositions outside of the currently known art in the field of contact lens care.

The moldings of the present invention may be advantageously formed into contact lenses or intraocular lenses that exhibit “minimal expansion or contraction”; that is, they exhibit little or no expansion or contraction of the gel upon placement into saline solution. This may be accomplished by adjusting the amount of diluent present such that no net volume change of the gel occurs when the molding is equilibrated in a saline environment. This goal can be readily achieved by using saline as the sole diluent so long as it is incorporated at the same concentration in the semi-solid precursor mixture as its equilibrium content after gel formation, which can be readily determined by simple trial and error experimentation. Should one prefer the use of other diluents either with or without the presence of saline in the semi-solid precursor mixture, then the diluent concentration leading to no net volume change of the gel when equilibrated with saline may not be the same as the equilibrium saline concentration but, again, can again be readily ascertained by simple trial and error experimentation.

“Extraction” is the process by which unwanted or undesirable species (usually small molecule impurities, polymerization by-products, unpolymerized or partially polymerized monomer, etc., sometimes referred to as extractables) are removed from a cured gel prior to its intended use. By “prior to its intended use” is meant, for example in the case of a contact lens, prior to insertion into the eye. Extraction steps are a required feature of prior art processes used to make contact lenses, for example (see U.S. Pat. Nos. 3,408,429 and 4,347,198), which add undue complications, processing time, and expense to the molding production process.

An advantage of the present invention is that moldings can be produced that do not require an extraction step, or require only a minimal extraction step, once the polymerization step is complete. By “minimal extraction step” and “minimum extraction” are meant that the amount of extractables is sufficiently low and/or the extractable composition is sufficiently non-toxic that any required extraction may be accommodated by the fluid within the container in which the lens is packaged for shipment to the consumer. The phrases “minimal extraction step” and “minimum extraction” may furthermore comprise any washing or rinsing that occurs as a part of any aspect of the demolding operation, as well as any handling steps. That is, liquid jets are sometimes used to facilitate movement of the lens from one container to another, demolding from one or more of the lens molds, etc., said jets generally comprising focused water or saline solution streams. During these processes, some extraction or rinsing away of any extractable lens materials may be reasonably expected to occur, but in any case shall be deemed to fall under the class of materials and processes requiring a minimal extraction step, as presented in this disclosure.

As an example, in one embodiment of the present invention, the semi-solid precursor mixture comprises 30-70 wt % of a prepolymer blended with a photoinitiator and a non-reactive diluent that is selected from the group consisting of water and FDA-approved ophthalmic demulcents. Upon polymerization, the molding may be placed directly into a contact lens packaging container containing about 3.5 mL of saline fluid for storage, with the aid of one or more liquid jets to aid in the demolding process and to further facilitate lens handling without mechanical contact (see for example, U.S. Pat. No. 5,836,323), whereupon the molding will equilibrate with the surrounding fluid in the package. Since the molding volume of a contact lens (e.g., ˜0.050 mL) is small relative to the fluid volume in the lens package, the demulcent concentration will be at least about 1 wt % or lower in both the solution and the lens after equilibration, which concentration is acceptable for direct application to the eye by the consumer. Thus, while from a strict viewpoint an extraction step is used in this embodiment, the extraction step is reduced to a minimal extraction step—that which occurs inherently during the demolding, handling and packaging processes. The fact that no separate extraction step is used per se represents a significant advantage of the present invention disclosed herein.

### DETAILED DESCRIPTION OF THE INVENTION

In one embodiment, the present invention relates to prepolymers in which the linkage of the functional groups to the polymer backbone is through covalent attachment at one or more sites along the prepolymer chain. In a further embodiment, the present invention relates to prepolymers that are not substantially water-soluble. By “water-soluble” is meant that the prepolymers are capable of being dissolved in water or saline solutions over the entire concentration range of about 1-10 wt % prepolymer under ambient conditions, or more preferably about 1-70% prepolymer in water or saline solutions. Thus, non-water-soluble prepolymers shall be those which do not completely dissolve in water over the concentration range of about 1-10% in water at ambient conditions. In a preferred embodiment, gels made from prepolymers that are non-water-soluble may be water-swellable such that they are capable of producing a homogeneous mixture upon absorbing from 10 to 90% water. Generally, such water-swellable gels will exhibit a maximum water absorption (i.e., equilibrium water content) that is a function of the chemical composition of the polymers making up the gel, as well as the gel crosslink density. Preferred gels in accordance with this invention are those exhibiting an equilibrium water content of from about 20 to 80 wt % water in a water or saline solution. When crosslinked, such non-water-soluble but water-swellable materials desirably produce hydrogels, which are useful products of the present invention.

In a preferred embodiment of the invention, a homogenous semi-solid mixture of one or more prepolymers and one or more non-reactive diluents is constituted that is substantially free from monomeric, oligomeric, or polymeric compounds used in (and by-products formed during) the preparation of the prepolymer, as well as being free of any other unwanted constituents such as impurities or diluents that are not ophthalmic demulcents. By “substantially free” is meant herein that the concentration of the undesirable constituents in the semi-solid precursor mixture is preferably less than 0.001% by weight, and more preferably less than 0.0001% (1 ppm). The acceptable concentration range for such undesirable constituents shall ultimately be determined by the intended use of the final product. This mixture preferably contains only diluents that are water or are recognized by the FDA as acceptable ophthalmic demulcents in limited concentrations in the eye. The mixture is furthermore constituted so as to not contain any additional co-monomers or reactive plasticizers. In this manner a semi-solid precursor mixture is constituted which contains no or essentially no unwanted constituents, and thus the molding produced therefrom contains no or essentially no unwanted constituents. Moldings are therefore produced which do not require the use of a separate extraction step, aside from the extraction/equilibration process which occurs within the packaging container and during demolding and intermediate handling steps after the cured molding has been produced.

Prepolymers suitable for use in the practice of this invention include any any thermoplastic material that possesses one or more pendant or terminal functionality (i.e., reactive group) along the oligomer or polymer backbone. Furthermore, oligomers or polymers that undergo grafting reactions or other crosslinking reactions in the presence of a polymerizing system (monomers, oligomers, initiators, and/or a source of polymerizing energy) may be used as prepolymers to constitute the semi-solid precursor mixtures of this invention. By way of example, suitable prepolymers for the practice of the current invention include (meth)acrylate-, (meth)acrylic anhydride-, (meth)acrylamide-, vinyl-, vinyl ether-, vinyl ester-, vinyl halide-, vinyl silane-, vinyl siloxane-, vinyl heterocycle-, diene-, allyl-, and epoxy-functionalized versions of: polystyrene, poly(α-methyl styrene), polymaleic anhydride, polystyrene-co-maleic anhydride, polymethyl(meth)acrylate, polybutyl(meth)acrylate, poly-iso-butyl (meth)acrylate, poly-2-butoxyethyl (meth)acrylate, poly-2-ethoxyethyl (meth)acrylate, poly(2-(2-ethoxy)ethoxy)ethyl (meth)acrylate, poly(2-hydroxyethyl (meth)acrylate), poly(hydroxypropyl (meth)acrylate), poly(cyclohexyl (meth)acrylate), poly(isobornyl (meth)acrylate), poly(2-ethylhexyl (meth)acrylate), polytetrahydrofurfuryl (meth)acrylate, polyethylene, polypropylene, polyisoprene, poly(1-butene), polyisobutylene, polybutadiene, poly(4-methyl-1-pentene), polyethylene-co-(meth)acrylic acid, polyethylene-co-vinyl acetate, polyethylene-co-vinyl alcohol, polyethylene-co-ethyl (meth)acrylate, polyvinyl acetate, polyvinyl butyral, polyvinyl butyrate, polyvinyl valerate, polyvinyl formal, polyethylene adipate, polyethylene azelate, polyoctadecene-co-maleic anhydride, poly(meth)acrylonitrile, polyacrylonitrile-co-butadiene, polyacrylonitrile-co-methyl (meth)acrylate, poly(acrylonitrile-butadiene-styrene), polychloroprene, polyvinyl chloride, polyvinylidene chloride, polycarbonate, polysulfone, polyphosphine oxides, polyetherimide, nylon (6, 6/6, 6/9, 6/10, 6/12, 11, and 12), poly(1,4-butylene adipate), polyhexafluoropropylene oxide, phenoxy resins, acetal resins, polyamide resins, poly(2,3-dihydrofuran), polydiphenoxyphosphazene, mono-, di-, tri-, tetra-, . . . polyethylene glycol, mono-, di-, tri-, tetra-, . . . polypropylene glycol, mono-, di-, tri-, tetra-, . . . polyglycerol, polyvinyl alcohol, poly-2 or 4-vinyl pyridine, poly-N-vinylpyrrolidone, poly-2-ethyl-2-ozazoline, the poly-N-oxides of pyridine, pyrrole, imidazole, pyrazole, pyrazine, pyrimidine, pyridazine, piperadine, azolidine, and morpholine, polycaprolactone, poly(caprolactone)diol, poly(caprolactone)triol, poly(meth)acrylamide, poly(meth)acrylic acid, polygalacturonic acid, poly(t-butylaminoethyl (meth)acrylate), poly(dimethylaminoethyl (meth)acrylate), polyethyleneimine, polyimidazoline, polymethyl vinyl ether, polyethyl vinyl ether, polymethyl vinyl ether-co-maleic anhydride, cellulose, cellulose acetate, cellulose nitrate, methyl cellulose, carboxymethyl cellulose, ethyl cellulose, ethyl hydroxyethyl cellulose, hydroxybutyl cellulose, hydroxypropyl cellulose, hydroxypropyl methyl cellulose, starch, dextran, gelatin, polysaccharides/glucosides such as glucose and sucrose, polysorbate 80, zein, polydimethylsiloxane, polydimethylsilane, polydiethoxysiloxane, polydimethylsiloxane-co-methylphenylsiloxane, polydimethylsiloxane-co-diphenylsiloxane, and polymethylhydrosiloxane. Ethoxylated and propoxylated versions of the above-mentioned polymers, as well as their copolymers, are also suitable for use as prepolymers in the present disclosure. Other less known but polymerizable functional groups can be employed, such as epoxies (with hardeners) and urethanes (reaction between isocyanates and alcohols).

Note, notations such as “(meth)acrylate” or “(meth)acrylamide” are used to denote optional methyl substitutions. The notation “mono-, di-, tri-, tetra-, . . . poly-” is used to denote monomers, dimers, trimers, tetramers, etc., up to and including polymers of the given repeat unit.

Preferred prepolymers are those polymers or copolymers comprising sulfoxide, sulfide, and/or sulfone groups within or pendant to the polymer backbone structure that have been functionalized with additional reactive groups. Gels resulting from sulfoxide-, sulfide-, and/or sulfone-containing monomers (without the added reactive groups after initial polymerization) have shown reduced protein adsorption in conventional contact lens formulations (see, U.S. Pat. No. 6,107,365 and PCT International Pubin. WO0002937) and are readily incorporated into the semi-solid precursor mixtures of the present invention.

Additionally, preferred prepolymers are those containing one or more pendant or terminal hydroxy groups, some portion of which have been functionalized with reactive groups capable of undergoing free-radical based polymerization. Examples of such prepolymers include functionalized versions of polyhydroxyethyl (meth)acrylate, polyhydroxypropyl (meth)acrylate, polyethylene glycol, cellulose, dextran, glucose, sucrose, polyvinyl alcohol, polyethylene-co-vinyl alcohol, mono-, di-, tri-, tetra-, . . . polybisphenol A, and adducts of Σ-caprolactone with C₂₋₆ alkane diols and triols. Copolymers, ethoxylated, and propoxylated versions of the above-mentioned polymers are also preferred prepolymers (see, for example PCT International Pubin. No. WO09837441).

Copolymers of these polymers with other monomers and materials suitable for use as ophthalmic lens materials are also disclosed. Additional monomers used for copolymerization may include, by way of example and without limitation, vinyl lactams such as N-vinyl-2-pyrrolidone, (meth)acrylamides such as N,N-dimethyl(meth)acrylamide and diacetone (meth)acrylamide, vinyl acrylic acids such as (meth)acrylic acid, acrylates and methacrylates such as 2-ethylhexyl (meth)acrylate, cyclohexyl (meth)acrylate, methyl (meth)acrylate, isobornyl (meth)acrylate, ethoxyethyl (meth)acrylate, methoxyethyl (meth)acrylate, methoxy triethyleneglycol (meth)acrylate, hydroxytrimeththylene (meth)acrylate, glyceryl (meth)acrylate, dimethylamino ethyl(meth)acrylate and glycidyl (meth)acrylate, styrene, and monomers/backbone units containing quarternary ammonium salts.

Particularly preferred prepolymers are methacrylate- or acrylate-functionalized poly(hydroxyethyl methacrylate-co-methacrylic acid) copolymers. Most preferred prepolymers are copolymers of hydroxyethyl methacrylate with about 2% methacrylic acid, where about 0.2-5% of the pendant hydroxyl groups of the copolymer have been functionalized with methacrylate groups to give a reactive prepolymer suitable for the semi-solid precursor mixtures and the process of this invention. A more preferable degree of methacrylate functionalization is about 0.5-2% of the hydroxyl groups.

In addition to or in place of prepolymers, systems of interest to the present application may comprise one or more substantially unreactive polymeric components, i.e., dead polymers. The polymeric component(s) may be linear, branched, or crosslinked. The simplest of such systems might be considered to be ordinary homopolymers, in which a reactive plasticizer and an initiator may be easily incorporated and reacted. In such cases, the reactive plasticizer is generally chosen to be compatible with the dead polymer of interest, at least at some desired processing conditions of temperature and pressure. “Compatibility” refers to the thermodynamic state where the reactive plasticizer solvates and/or plasticizes the dead polymer. In practice it has been found that molecular segments with structural similarity promote mutual dissolution. Hence, aromatic moieties on the polymer generally dissolve in aromatic plasticizers, and vice versa. Hydrophilicity and hydrophobicity are additional considerations in choosing the reactive plasticizers the dead polymers for the semi-solid precursor mixture. Compatibility may generally be assumed in systems that appear clear or transparent upon mixing, although for the purposes of this invention, compatibility is not required, but is merely preferred, especially when transparent objects are to be produced.

Even when only partial compatibility is observed at room temperature, the mixture often becomes uniform at a slightly increased temperature; i.e., many systems become clear at slightly elevated temperatures. Such temperatures may be slightly above ambient temperatures or may extend up to the vicinity of 100° C. or more. In such cases, the reactive components can be quickly cured at the elevated temperature to “lock-in” the compatible phase-state in the cured resin before system cool-down. Thus, phase-morphology trapping can be used to produce an optically clear material instead of a translucent or opaque material that would otherwise form upon cooling, which is yet another advantage presented in the current disclosure.

Optically transparent phase-separated systems may be beneficially prepared by including a phase-separated iso-refractive dead polymer, dead polymer mixture, prepolymer, prepolymer mixture, or a mixture of dead polymers and prepolymers in the system. When a reactive plasticizer is added which either (1) partitions itself approximately equally between the phases or (2) has a refractive index upon polymerizing similar to that of the dead polymer mixture, a clear part results upon curing. Alternatively, when the reactive plasticizer does not partition itself equally between the phases and does not possess a refractive index upon curing similar to the polymer mixture, the refractive index of one of the phases may be altered by appropriate choice of the polymer composition to give a resultant iso-refractive mixture. Such manipulations may be advantageously carried out in accordance with the present invention in order to realize heretofore-unattainable properties (i.e., simultaneous mechanical, optical, and processing properties) for a given material system.

The production of optically clear materials not withstanding, virtually any thermoplastic may be used as the dead polymer for the production of morphology-trapped materials. By way of example, these may include, but are not limited to: polystyrene, poly(α-methyl styrene), polymaleic anhydride, polystyrene-co-maleic anhydride, polymethyl(meth)acrylate, polybutyl(meth)acrylate, poly-iso-butyl (meth)acrylate, poly-2-butoxyethyl (meth)acrylate, poly-2-ethoxyethyl (meth)acrylate, poly(2-(2-ethoxy)ethoxy)ethyl (meth)acrylate, poly(2-hydroxyethyl (meth)acrylate), poly(hydroxypropyl (meth)acrylate), poly(cyclohexyl (meth)acrylate), poly(isobornyl (meth)acrylate), poly(2-ethylhexyl (meth)acrylate), polytetrahydrofurfuryl (meth)acrylate, polyethylene, polypropylene, polyisoprene, poly(1-butene), polyisobutylene, polybutadiene, poly(4-methyl-1-pentene), polyethylene-co-(meth)acrylic acid, polyethylene-co-vinyl acetate, polyethylene-co-vinyl alcohol, polyethylene-co-ethyl (meth)acrylate, polyvinyl acetate, polyvinyl butyral, polyvinyl butyrate, polyvinyl valerate, polyvinyl formal, polyethylene adipate, polyethylene azelate, polyoctadecene-co-maleic anhydride, poly(meth)acrylonitrile, polyacrylonitrile-co-butadiene, polyacrylonitrile-co-methyl (meth)acrylate, poly(acrylonitrile-butadiene-styrene), polychloroprene, polyvinyl chloride, polyvinylidene chloride, polycarbonate, polysulfone, polyphosphine oxides, polyetherimide, nylon (6, 616, 6/9, 6/10, 6/12, 11, and 12), poly(1,4-butylene adipate), polyhexafluoropropylene oxide, phenoxy resins, acetal resins, polyamide resins, poly(2,3-dihydrofuran), polydiphenoxyphosphazene, mono-, di-, tri-, tetra-, . . . polyethylene glycol, mono-, di-, tri-, tetra-, . . . polypropylene glycol, mono-, di-, tri-, tetra-, . . . polyglycerol, polyvinyl alcohol, poly-2 or 4-vinyl pyridine, poly-N-vinylpyrrolidone, poly-2-ethyl-2-ozazoline, the poly-N-oxides of pyridine, pyrrole, imidazole, pyrazole, pyrazine, pyrimidine, pyridazine, piperadine, azolidine, and morpholine, polycaprolactone, poly(caprolactone)diol, poly(caprolactone)triol, poly(meth)acrylamide, poly(meth)acrylic acid, polygalacturonic acid, poly(t-butylaminoethyl (meth)acrylate), poly(dimethylaminoethyl (meth)acrylate), polyethyleneimine, polyimidazoline, polymethyl vinyl ether, polyethyl vinyl ether, polymethyl vinyl ether-co-maleic anhydride, cellulose, cellulose acetate, cellulose nitrate, methyl cellulose, carboxy methyl cellulose, ethyl cellulose, ethyl hydroxyethyl cellulose, hydroxybutyl cellulose, hydroxypropyl cellulose, hydroxypropyl methyl cellulose, starch, dextran, gelatin, polysaccharides/glucosides such as glucose and sucrose, polysorbate 80, zein, polydimethylsiloxane, polydimethylsilane, polydiethoxysiloxane, polydimethylsiloxane-co-methylphenylsiloxane, polydimethylsiloxane-co-diphenylsiloxane, and polymethylhydrosiloxane. The ethoxylated and/or propoxylated versions of the above-mentioned polymers shall also be included under this disclosure as being suitable dead polymers.

Preferred dead polymers are those polymers or copolymers comprising sulfoxide, sulfide, and/or sulfone groups within or pendant to the polymer backbone structure. Gels containing these groups have shown reduced protein adsorption in conventional contact lens formulations (see U.S. Pat. No. 6,107,365, and PCT Publ. No. WO0002937), and are readily incorporated into the semi-solid precursor mixtures of the present invention.

Additionally preferred dead polymers are those containing one or more pendant or terminal hydroxy groups. Examples of such polymers include polyhydroxyethyl (meth)acrylate, polyhydroxypropyl (meth)acrylate, polyethylene glycol, cellulose, dextran, glucose, sucrose, polyvinyl alcohol, polyethylene-co-vinyl alcohol, mono-, di-, tri-, tetra-, . . . polybisphenol A, and adducts of ε-caprolactone with C₂₋₆ alkane diols and triols. Copolymers, ethoxylated, and propoxylated versions of the above-mentioned polymers are also preferred prepolymers.

Copolymers of these polymers with other monomers and materials suitable for use as ophthalmic lens materials are also disclosed. Additional monomers used for copolymerization of the dead polymers may include, by way of example and without limitation, vinyl lactams such as N-vinyl-2-pyrrolidone, (meth)acrylamides such as N,N-dimethyl(meth)acrylamide and diacetone (meth)acrylamide, vinyl acrylic acids such as (meth)acrylic acid, acrylates and methacrylates such as 2-ethylhexyl (meth)acrylate, cyclohexyl (meth)acrylate, methyl (meth)acrylate, isobornyl (meth)acrylate, ethoxyethyl (meth)acrylate, methoxyethyl (meth)acrylate, methoxy triethyleneglycol (meth)acrylate, hydroxytrimeththylene (meth)acrylate, glyceryl (meth)acrylate, dimethylamino ethyl(meth)acrylate and glycidyl (meth)acrylate, styrene, and monomers/backbone units containing quarternary ammonium salts.

The thermoplastics may optionally have small amounts of reactive entities attached (copolymerized, grafted, or otherwise incorporated) to the polymer backbone to promote crosslinking upon cure. They may be amorphous or crystalline. They may be classified as high performance engineering thermoplastics (e.g., polyether imides, polysulfones, polyether ketones, etc.), or they may be biodegradable, naturally occurring polymers (starch, prolamine, and cellulose, for example). They may be oligomeric or macromeric in nature. These examples are not meant to limit the scope of compositions possible during the practice of the current invention, but merely to illustrate the broad selection of thermoplastic chemistries permitted under the present disclosure.

Thermoplastic polymers may be chosen in order to give optical clarity, high index of refraction, low birefringence, exceptional impact resistance, thermal stability, UV transparency or blocking, tear or puncture resistance, desired levels or porosity, desired water content upon equilibration in saline, selective permeability to desired permeants (high oxygen permeability, for example), resistance to deformation, low cost, or a combination of these and/or other properties in the finished object.

Polymer blends achieved by physically mixing two or more polymers are often used to elicit desirable mechanical properties in a given material system. For example, impact modifiers (usually lightly crosslinked particles or linear polymer chains) may be blended into various thermoplastics or thermoplastic elastomers to improve the impart strength of the final cured resin. In practice, such blends may be mechanical, latex, or solvent-cast blends; graft-type blends (surface modification grafts, occasional grafts (IPNs, mechanochemical blends)), or block copolymers. Depending on the chemical structure, molecule size, and molecular architecture of the polymers, the blend may result in mixtures comprising both compatible and incompatible, amorphous or crystalline constituents.

Most polymer blends and block copolymers, and many other copolymers, result in phase-separated systems, providing an abundance of phase configurations to be exploited by the materials designer. The physical arrangement of the phase domains may be simple or complex, and may exhibit continuous, discrete/discontinuous, and/or bicontinuous morphologies. Some of these are illustrated by the following examples: spheres of phase I dispersed in phase II; cylinders of phase I dispersed in phase II; interconnected cylinders; ordered bicontinuous, double-diamond interconnected cylinders of phase I in phase II (as have been documented for star-shaped block copolymers); alternating lamellae (well-known for di-block copolymers of nearly equal chain length); rings forming nested spherical shells or spirals; phase within a phase within a phase (HIPS and ABS); and simultaneous multiples of these morphologies resulting from the thermodynamics of phase separation (both nucleation and growth as well as spinodal decomposition mechanisms), kinetics of phase separation, and methods of mixing, or combinations thereof.

Another category of materials utilizes “thermoplastic elastomers” as the dead polymer or prepolymer (when functionalized). An exemplary thermoplastic elastomer is a tri-block copolymer of the general structure “A-B-A”, where A is a thermoplastic rigid polymer (i.e., having a glass transition temperature above ambient) and B is an elastomeric (rubbery) polymer (glass transition temperature below ambient). In the pure state, ABA forms a microphase-separated or nanophase-separated morphology. This morphology consists of rigid glassy polymer regions (A) connected and surrounded by rubbery chains (B), or occlusions of the rubbery phase (B) surrounded by a glassy (A) continuous phase. Depending on the relative amounts of (A) and (B) in the polymer, the shape or configuration of the polymer chain (i.e., linear, branched, star-shaped, asymmetrical star-shaped, etc.), and the processing conditions used, alternating lamellae, semi-continuous rods, or other phase-domain structures may be observed in thermoplastic elastomer materials. Under certain compositional and processing conditions, the morphology is such that the relevant domain size is smaller than the wavelength of visible light. Hence, parts made of such ABA copolymers can be transparent or at worst translucent. Thermoplastic elastomers, without vulcanization, have rubber-like properties similar to those of conventional rubber vulcanizates, but flow as thermoplastics at temperatures above the glass transition point of the glassy polymer region. Commercially important thermoplastic elastomers are exemplified by SBS, SIS, and SEBS, where S is polystyrene and B is polybutadiene, I is polyisoprene, and EB is ethylenebutylene copolymer. Many other di-block or tri-block candidates are known, such as poly(aromatic amide)-siloxane, polyimide-siloxane, and polyurethanes. SBS and hydrogenated SBS (i.e., SEBS) are well-known products from Ripplewood Holdings (Kraton®). DuPont's Lycra® is also a block copolymer.

When thermoplastic elastomers are chosen as the starting prepolymer and/or dead polymer for formulation, exceptionally impact-resistant yet clear parts may be manufactured by mixing with reactive plasticizers. The thermoplastic elastomers, by themselves, are not chemically crosslinked and require relatively high-temperature processing steps for molding. Upon cooling, such temperature fluctuations lead to dimensionally unstable, shrunken or warped parts. The reactive plasticizers, if cured by themselves, may be chosen to form a relatively glassy, rigid network or a relatively soft, rubbery network, but with relatively high shrinkage in either case. When thermoplastic elastomers (i.e., dead polymers or prepolymers) and reactive plasticizers are blended together and reacted to form a cured resin, however, they form composite networks with superior shock-absorbing and impact-resistant properties, while exhibiting relatively little shrinkage during cure. By “impact-resistant” is meant resistance to fracture or shattering upon being struck by an incident object.

Depending on the nature of the prepolymers, dead polymers, diluents and/or reactive plasticizers used in the formulation, the final cured resin may be more flexible or less flexible (alternatively, harder or softer) than the starting prepolymer or dead polymer. Composite articles exhibiting exceptional toughness may be fabricated by using a thermoplastic elastomer which itself contains polymerizable groups along the polymer chain. A preferred composition in this regard would be SBS tri-block or star-shaped copolymers, for example, in which the reactive plasticizer is believed to crosslink lightly with the unsaturated groups in the butadiene segments of the SBS polymer.

A preferred formulation for developing optically clear and highly impact-resistant materials uses styrene-rich SBS tri-block copolymers that contain up to about 75% styrene. These SBS copolymers are commercially available from Ripplewood Holdings (Kraton®), Phillips Chemical Company (K-Resin®), BASF (Styrolux®), Fina Chemicals (Finaclear®), Asahi Chemical (Asaflex®), and others. In addition to high impact resistance and good optical clarity, such styrene-rich copolymers yield material systems which exhibit other sometimes desirable properties such as a relatively high refractive index (that is, an index of refraction equal to or greater than about 1.54) and/or low density (with 30% or less of a reactive plasticizer, their densities are less than about 1.2 g/cc, and more typically about 1.0 g/cc).

When the mixture refractive index is an especially important consideration, high refractive index polymers may be used as one or more of the dead-polymer components. Examples of such polymers include polycarbonates and halogenated and/or sulfonated polycarbonates, polystyrenes and halogenated and/or sulfonated polystyrenes, polystyrene-polybutadiene block copolymers and their hydrogenated, sulfonated, and/or halogenated versions (all of which may be linear, branched, star-shaped, or non-symmetrically branched or star-shaped, etc.), polystyrene-polyisoprene block copolymers and their hydrogenated, sulfonated and/or halogenated versions (including the linear, branched, star-shaped, and non-symmetrical branched and star-shaped variations, etc.), polyethylene or polybutylene terephthalates (or other variations thereof), poly(pentabromophenyl (meth)acrylate), polyvinyl carbazole, polyvinyl naphthalene, poly vinyl biphenyl, polynaphthyl (meth)acrylate, polyvinyl thiophene, polysulfones, polyphenylene sulfides or oxides, polyphosphine oxides or phosphine oxide-containing polyethers, urea-, phenol-, or naphthyl-formaldehyde resins, polyvinyl phenol, chlorinated or brominated polystyrenes, poly(phenyl α- or β-bromoacrylate), polyvinylidene chloride or bromide, and the like.

In general, increasing the aromatic content, the halogen content (especially bromine), and/or the sulfur content are effective means well known in the art for increasing the refractive index of a material. High index, low density, and resistance to impact are properties especially preferred for ophthalmic lenses as they enable the production of ultra thin, lightweight eyeglass lenses, which are desirable for low-profile appearances and comfort and safety of the wearer.

Alternatively, elastomers, thermosets (e.g., epoxies, melamines, acrylated epoxies, acrylated urethanes, etc., in their uncured state), and other non-thermoplastic polymeric compositions may be desirably utilized during the practice of this invention.

Reactive plasticizers may be mixed with a thermoplastic prepolymer and/or dead polymer such as those listed above to give a semi-solid-like composition that can be easily molded into dimensionally precise objects. Upon polymerizing to form a cured resin, the phase morphology within the material just prior to cure is locked in to give a composite that exhibits an increased degree of morphological stability. In such cases, the presence of the diluents and/or reactive plasticizers may facilitate blending by lowering the softening temperature of the polymers to be blended. This is especially advantageous when temperature-sensitive materials are being blended with high-T_{g} polymers. When optically clear materials are desired, the mixture components (i.e., the prepolymers, dead polymers, the impact modifiers, non-reactive diluents, and/or the reactive plasticizers) may be chosen to produce the same refractive index between the phases (iso-refractive) such that light scattering is reduced. When iso-refractive components are not available, the diluents and reactive plasticizers may nonetheless act as compatibilizers to help reduce the domain size between two immiscible polymers to below the wavelength of light, thus producing an optically clear polymer mixture that would otherwise have been opaque. The presence of reactive plasticizers may also in some cases improve the adhesion between the impact modifier and the dead polymer, improving the resultant mixture properties.

The reactive plasticizers can be used singly or in mixtures to facilitate dissolution of a given prepolymer or dead polymer. The reactive functional group may be acrylate, methacrylate, acrylic anhydride, acrylamide, vinyl, vinyl ether, vinyl ester, vinyl halide, vinyl silane, vinyl siloxane, (meth)acrylated silicones, vinyl heterocycles, diene, allyl and the like. Other less known but polymerizable functional groups can be employed, such as epoxies (with hardeners) and urethanes (reaction between isocyanates and alcohols). In principle, any monomers may be used as reactive plasticizers in accordance with the present invention, although preference is given to those which exist as liquids at ambient temperatures or slightly above, and which polymerize readily and rapidly with the application of a source of polymerizing energy such as light or heat in the presence of a suitable initiator.

Reactive monomers, oligomers, and crosslinkers that contain acrylate or methacrylate functional groups are well known and commercially available from Sartomer, Radcure and Henkel. Similarly, vinyl ethers are commercially available from Allied Signal/Morflex. Radcure also supplies UV curable cycloaliphatic epoxy resins. Vinyl, diene, and allyl compounds are available from a large number of chemical suppliers.

To demonstrate the great diversity of reactive plasticizers that can be used to achieve such compatibility, we will name only a few from a list of hundreds to thousands of commercially available compounds. For example, mono-functional entities include, but are not limited to: butyl (meth)acrylate; octyl (meth)acrylate; isodecyl (meth)acrylate; hexadecyl (meth)acrylate; stearyl (meth)acrylate; isobornyl (meth)acrylate; vinyl benzoate; tetrahydrofurfuryl (meth)acrylate; caprolactone (meth)acrylate; cyclohexyl (meth)acrylate; benzyl (meth)acrylate; ethylene glycol phenyl ether (meth)acrylate; methyl (meth)acrylate; ethyl (meth)acrylate; and propyl (meth)acrylate; hydroxyethylmethacrylate (HEMA); 2-hydroxyethylacrylate (HEA); methylacrylamide (MMA); methacrylamide; N,N-dimethyl-diacetone(meth)acrylamide; 2-phosphatoethyl(meth)acrylate; mono-, di-,tri-, tetra-, penta-, . . . polyethylenglycol mono(meth)acrylate; 1,2-butylene (meth)acrylate; 1,3 butylene (meth)acrylate; 1,4-butylene (meth)acrylate; mono-, di-, tri-, tetra-, . . . polypropylene glycol mono(meth)acrylate; gylcerine mono(meth)acrylate; 4- and 2-methyl-5-vinylpyridine; N(3-(meth)acrylamidopropyl)-N,N-dimethylamine; N-(3-(meth)acrylamidopropyl)-N,N,N-trimethylamine; 1-vinyl-, and 2-methyl-1-vinlymidazole; N-(3-(meth)acrylamido-3-methylbutyl)-N,N-dimethylamine; N-methyl(meth)acrylamide; 3-hydroxypropyl (meth)acrylate; N-vinyl imidazole; N-vinyl succinimide; N-vinyl diglycolylimide; N-vinyl glutarimide; N-vinyl-3-morpholinone; N-vinyl-5-methyl-3-morpholinone; propyl (meth)acrylate; butyl (meth)acrylate; pentyl (meth)acrylate; dimethyidiphenyl methylvinyl siloxane; N-(1,1-dimethyl-3-oxobutyl) (meth)acrylamide; 2-ethyl-2-(hydroxy-methyl)-1,3-propanediol trimethyl(meth)acrylate; X-(dimethylvinylsilyl)-ω-[(dimethylvinyl-silyl)oxy]-dimethyl diphenyl methylvinyl siloxane; butyl(meth)acrylate; 2-hydroxybutyl (meth)acrylate; vinyl acetate; pentyl (meth)acrylate; vinyl propionate; 3-hydroxy-2-naphtyl (meth)acrylate; vinyl alcohol; N-(formylmethyl)(meth)acrylamide; 2-ethoxyethyl (meth)acrylate; 4-t-butyl-2-hydroxycyclohexyl (meth)acrylate; 2-((meth)acryloyloxy)ethyl vinyl carbonate; vinyl[3-[3,3,3-trimethyl-1,1-bis(trimethylsiloxy)disiloxany]propyl] carbonate; 4,4′-(tetrapentacontmethylhepta-cosasiloxanylene)di-1-butanol; N-carboxy-β-alanine N-vinyl ester; 2-methacryloylethyl phosphorylcholine; methacryloxyethyl vinyl urea; and the like.

Multifunctional entities include, but are not limited to: mono-, di-, tri-, tetra-, . . . polyethylene glycol di(meth)acrylate; 1,2-butylene di(meth)acrylate; 1,3 butylenedi(meth)acrylate; 1,4-butylene di(meth)acrylate; mono-, di-, tri-, tetra-, . . . polypropylene glycol di(meth)acrylate; gylcerine di- and tri-(meth)acrylate; trimethylol propane tri(meth)acrylate (and its ethoxylated and/or propoxylated derivatives); pentaerythritol tetraacrylate (and its ethoxylated and/or propoxylated derivatives); hexanediol di(meth)acrylate; bisphenol A di(meth)acrylate; ethoxylated (and/or propoxylated) bisphenol A di(meth)acrylate; (meth)acrylated methyl glucoside (and its ethoxylated and/or prpoxylated versions); (meth)acrylated polycaprolactone triol (and its ethoxylated and/or prpoxylated versions); methylenebisacrylamide; triallylcyanurate; dinvinyl benzene; diallyl itaconate; allyl methacrylate; diallyl phthalate; polysiloxanylbisalkyl (meth)acrylate; methacryloxyethyl vinyl carbonate; polybutadiene di(meth)acrylate; and a whole host of aliphatic and aromatic (meth)acrylated oligomers and (meth)acrylated urethane-based oligomers from Sartomer (the SR series), Radcure (the Ebecryl® series), and Henkel (the Photomer® series). Typical crosslinking agents usually, but not necessarily, have at least two ethylenically unsaturated double bonds.

Additional highly hydrophilic monomers or comonomers useful in the present invention include, but are not limited to, acrylic acid; methacrylic acid; (meth)acrylamide- or (meth)acrylate-functionalized carbohydrate-, sulfoxide-, sulfide- or sulfone-based monomers such as those disclosed in U.S. Pat. Nos. 6,107,365 and 5,571,882; alkoxylated sucrose, glucose, and other glucosides such as those disclosed in U.S. Pat. Nos. 5,856,416, 5,690,953 and 5,654,350; N-vinylpyrrolidone; 2-acrylamido-2-methylpropanesulfonic acid and its salts; vinylsulfonic acid and its salts; styrenesulfonic acid and its salts; 3-methacryloyloxy propyl sulfonic acid and its salts; allylsulfonic acid; 2-methacryloyloxyethyltrimethylammonium salts; N,N,N-trimethylammonium salts; diallyl-dimethylammonium salts; 3-aminopropyl (meth)acrylamide-N,N-diacetic acid diethyl ester (as disclosed in U.S. Pat. No. 5,779,943); and the like.

When high refractive index materials are desired, the reactive plasticizers may be chosen accordingly to have high refractive indices. Examples of such reactive plasticizers, in addition to those mentioned above, include brominated or chlorinated phenyl (meth)acrylates (e.g., pentabromo methacrylate, tribromo acrylate, etc.), brominated or chlorinated naphthyl or biphenyl (meth)acrylates, brominated or chlorinated styrenes, tribromoneopentyl (meth)acrylate, vinyl naphthylene, vinyl biphenyl, vinyl phenol, vinyl carbazole, vinyl bromide or chloride, vinylidene bromide or chloride, bromoethyl (meth)acrylate, bromophenyl isocyanate, and the like. As stated previously, increasing the aromatic, sulfur and/or halogen content of the reactive plasticizers is a well-known technique for achieving high-refractive index properties.

In a presently preferred embodiment, reactive plasticizers containing acrylate, methacrylate, acrylamide, and/or vinyl ether moieties are found to give convenient, fast-curing UV-triggered systems.

The reactive plasticizers can be mixtures themselves, composed of mono-functional, bi-functional, tri-functional or other multi-functional entities. For example, incorporating a mixture of monofunctional and multi-functional reactive plasticizers will, upon polymerization, lead to a reactive plasticizer polymer network in which the reactive plasticizer polymer chains are crosslinked to each other (i.e., a semi-IPN). During polymerization, the growing reactive plasticizer polymer chains may react with the prepolymer, if present, to create an IPN. The reactive plasticizer (and prepolymer, if present) may also graft to or react with the dead polymer, creating a type of IPN, even if no unsaturated or other apparently reactive entities are present within the dead polymer chains. Thus, the prepolymer and dead polymer chains may act as crosslinking entities during cure, resulting in the formation of a crosslinked reactive plasticizer polymer network even when only monofunctional reactive plasticizers are present in the mixture with a only preolymers and/or dead polymers.

Non-reactive diluents may be advantageously added to the semi-solid precursor mixtures of the present invention in order to achieve compatibility of the mixture components, achieve the desired concentration of reactive functionalities, and to achieve the desired semi-solid consistency. Diluents are chosen based upon their compatibility with and plasticizing effects on the prepolymer, dead polymer, and reactive plasticizer constituents in the semi-solid precursor mixture. Typically, compatible mixtures are desired for the production of the moldings of interest, except where phase separation is either unavoidable or desired to achieve some desired material property in the final molding. For the production of ophthalmic lenses, clear systems upon cure are desirable, which can be easily achieved by selecting diluents that are compatible with the prepolymers and dead polymers of the semi-solid precursor mixture.

While the diluents are ostensibly unreactive in the polymerizing system of the semi-solid precursor material, some minor degree of reaction may in fact occur, and such reaction will generally be acceptable and unavoidable. Diluents may also affect the polymerization reaction by acting as chain terminating agents (a known phenomenon when water is present in anionic polymerization systems, for example), thus slowing the rate of cure, the final degree of cure, or the molecular weight distribution ultimately obtained. Fortunately, because the semi-solid systems of the present invention require little overall reaction from start to finish compared to predominantly monomeric systems, interference effects of the diluents will be greatly reduced, often to the point of having no measurable impact on the curing reaction. This greatly facilitates the choice of diluents that may be employed in the process of this invention, since reaction inhibition effects are less likely to arise.

By way of example, non-reactive diluents may include, but are not limited to: alcohols such as methanol, ethanol, propanol, butanol, pentanol, etc. and their methoxy and ethoxy ethers; glycols such as mono-, di-, tri-, tetra-, . . . polyethylene glycol and its mono- and di-methoxy and -ethoxy ethers, mono-, di-, tri-, tetra-, . . . polypropylene glycol and its mono- and di-methoxy and -ethoxy ethers, mono-, di-, tri-, tetra-, . . . polybutylene glycol and its mono- and di-methoxy and -ethoxy ethers, etc., mono-, di-, tri-, tetra-, . . . polyglycerol and its mono- and di-methoxy and -ethoxy ethers; alkoxylated glucosides such as the ethoxylated and propoxylated glucosides described in U.S. Pat. No. 5,684,058, and/or as sold under the “Glucam” trade name by Amerchol Corp.; ketones such as acetone, methyl ethyl ketone, methyl propyl ketone, methyl isobutyl ketone; esters such as ethyl acetate or isopropyl acetate; dimethyl sulfoxide, N-methylpyrrolidone, N,N-dimethyl formamide, N,N-dimethyl acetamide, cyclohexane, diacetone dialcohol, boric acid esters (such as with glycerol, sorbitol, or other polyhydroxy compounds, as disclosed in U.S. Pat. Nos. 4,495,313, 4,680,336, and 5,039,459), and the like.

The diluents employed for the production of contact lenses should ultimately be water-displaceable, although the diluents used in the production of moldings of interest may be first extracted with a solvent other than water, followed by water extraction in a second step, if desired.

“Over-the-counter” use of demulcents within ophthalmic compositions is regulated by the US Food & Drug Administration (FDA). For example, the Federal Register (21 CFR Part 349) entitled Ophthalmic Drug Products for Over-the-Counter Use: Final Monograph lists the accepted demulcents along with appropriate concentration ranges for each. Specifically, §349.12 lists the following approved “monograph” demulcents: (a) cellulose derivatives: (1) carboxymethyl cellulose sodium, (2) hydroxyethyl cellulose, (3) hydroxy propyl methyl cellulose, methylcellulose; (b) dextran 70; (c) gelatin; (d) polyols, liquid: (1) glycerin, (2) polyethylene glycol 300, (3) polyethylene glycol 400, (4) polysorbate 80, (5) propylene glycol; (e) polyvinyl alcohol; and (f) povidone (polyvinyl pyrrolidone). §349.30 further provides that in order to fall within the monograph, no more than three of the above-identified demulcents may be combined.

Diluents used in accordance with the present invention are preferably FDA-approved ophthalmic demulcents or mixtures of ophthalmic demulcents with water or saline solutions. In cases where water interferes with the polymerization process (which is less likely using semi-solid precursor mixtures than in convention polymerization schemes using liquid monomer precursors), pure demulcents or mixtures of demulcents with prepolymers, dead polymers, and/or reactive plasticizers may be employed. The concentration of the demulcents within the molding during cure may be much higher than the concentrations allowed by the FDA in cases where the moldings shall be diluted or equilibrated in water or saline solution prior to use by the consumer, such as the case where contact lens moldings are placed into a package with an excess of saline solution for storage and shipping.

In a preferred embodiment of the present invention, the diluent composition and concentration in the semi-solid precursor mixture is chosen such that upon polymerization and subsequent equilibration in saline solution, little net change in gel volume occurs. Preferably, gel volume changes by no more than 10% upon equilibration in a physiologically acceptable saline solution. More preferably, the gel volume changes by less than 5%, and even more preferably by less than 2%. Most preferably, the gel volume changes by less than 1% upon equilibration in saline after molding, cure and demolding.

Minimal gel volume changes upon equilibration in saline are made possible by the novel semi-solid precursor mixtures of the present invention because the semi-solid materials (1) exhibit low shrinkage upon cure, and (2) can be formulated to contain the exact amount of diluent necessary to compensate for the equilibrium content of water. This second condition is made possible because liquid systems are no longer required in formulating the precursor mixtures used in conventional molding operations. In contrast, the semi-solid consistency, which results from incorporating the correct amount of diluent such that no net gel volume change occurs upon equilibration in water, is utilized to the advantage of the present disclosure.

In another preferred embodiment, the diluent concentration is adjusted such that a fixed amount of gel swelling occurs upon equilibration in water. This is sometimes helpful to aid in the demolding process, and yet the gel volume change can be accommodated by an appropriate mold design which takes into account a small but fixed amount of swelling of the finished molding.

An initiator or polymerization catalyst is typically added into the semi-solid precursor mixture in order to facilitate curing upon exposure of the mixture to a source of polymerizing energy such as light or heat. The polymerization catalyst can be a thermal initiator which generates free radicals at moderately elevated temperatures. Thermal initiators such as such as lauryl peroxide, benzoyl peroxide, dicumyl peroxide, t-butyl hydroperoxide, azobisisobutyronitrile (AIBN), potassium or ammonium persulfate, for example, are well known and are available from chemical suppliers such as Aldrich. Photoinitiators may preferably be used in place of or in combination with one or more thermal initiators so that the polymerization reaction may be triggered by a source of actinic or ionic radiation. Photo-initiators such as the Irgacure® and Darocur® series are well-known and commercially available from Ciba Geigy, as is the Esacure® series from Sartomer. Example photoinitiator systems are benzoin methyl ether, 1-hydroxycyclohexyl phenyl ketone, 2-hydroxy-2-methyl-1-phenylpropane-1-one (sold under the Tradename Darocure 1173 by Ciba Specialty Chemicals), and 4,4′-azobis (4-cyano valeric acid), available from Aldrich Chemicals. For a reference on initiators, see, for example, Polymer Handbook, J. Brandrup, E. H. Immergut, eds., 3rd Ed., Wiley, New York, 1989.

The initiators are advantageously added into the precursor mixture prior to introduction into the mold. Optionally, other additives may be included such as mold release agents, preservative agents, pigments, dyes, organic or inorganic fibrous or particulate reinforcing or extending fillers, thixotropic agents, indicators, inhibitors or stabilizers (weathering or non-yellowing agents), UV absorbers, surfactants, flow aids, chain transfer agents, foaming agents, porosity modifiers, and the like. The initiator and other optional additives may be dissolved or dispersed in the reactive plasticizer and/or diluent component prior to combining with the dead polymer and/or prepolymer to facilitate complete dissolution into and uniform mixing with the polymeric component(s). Alternatively, the initiator and other optional additives may be added to the mixture at any time, including just prior to polymerization, which may be preferred when thermal initiators are used for example.

The ingredients in the polymerizing mixture can be blended by hand or by mechanical mixing. The ingredients may preferably be warmed slightly to soften or liquefy the prepolymer and/or dead polymer component. Any suitable mixing device may be used to mechanically homogenize the mixture, such as blenders, kneaders, internal mixers, compounders, extruders, mills, in-line mixers, static mixers, and the like, optionally blended at temperatures above ambient temperature, or optionally blended at pressures above or below atmospheric pressure.

In one presently preferred embodiment of the invention, an optional waiting period may be allowed during which the ingredients are not mechanically agitated. This optional waiting period may take place between the time the ingredients are initially metered into a holding container and the time at which they are homogenized mechanically or manually. Alternatively, the ingredients may be metered into a mixing device, said mixing device operated for a sufficient period to “dry-blend” the ingredients, then an optional waiting period may ensue before further mixing takes place. Or, the ingredients may be fully mixed in a mechanical device, after which time a waiting period ensues. The waiting period may extend for about an hour to one or more days. Such a waiting period is useful for achieving homogenization of a given polymer system down to very small length scales since mechanical mixing techniques do not usually achieve mixing at the length scale of microphase domains. Thus, a combination of both mechanical mixing and a waiting period may be used to achieve homogenization across all length scales. The waiting period duration and its order in the processing sequence may be chosen empirically and without undue experimentation as the period that gives the most efficient overall mixing process in terms of energy consumption. overall process economics, and final material properties.

This embodiment of the invention may be particularly beneficial when the polymerizable mixture contains a high fraction of the prepolymer or dead polymer ingredients, especially when the prepolymer or dead polymer is glassy or rigid at ambient temperatures. Utilization of a waiting period may also be particularly beneficial when the prepolymer and/or dead polymer are thermally sensitive and so cannot be processed at temperatures above their softening point over a certain time period without undue degradation.

When attempting to blend two or more polymers, it may be useful to add the non-reactive diluent and/or reactive plasticizer to the component with the highest glass transition temperature first, allowing it to be plasticized. The other lower T_{g} components may then be mixed in at a temperature lower than that which could have been used without the plasticizing effect of the diluents or reactive plasticizers, thus reducing the overall thermal exposure of the system. Alternatively, the diluents and reactive plasticizers may be partitioned between the polymers to be mixed, plasticizing each of them separately. The independently plasticized polymers may then be mixed at a relatively low temperature, with correspondingly lower energy consumption and degradation of the polymers.

The crucial criteria in determining whether a semi-solid precursor mixture can be employed in the novel process of the present invention for the production of ophthalmic moldings are that the precursor mixture must be homogeneous to a sufficient degree allowing for optical clarity upon cure; that the mixture exhibit a semi-solid consistency during at least one part of the manufacturing process used to produce the molding of interest; and that the mixture be capable of undergoing a polymerization reaction upon the application of light, heat, or some other form of polymerizing energy or polymerization-triggering mechanism.

The semi-solid precursor materials of the present invention may be advantageously molded by several different molding techniques well-known and commonly practiced in the art. For example, static casting techniques, where the molding material is placed between two mold halves which are then closed to define an internal cavity which in turn defines the molding shape to be produced, are well-known in the field of ophthalmic lens production. See, for example, U.S. Pat. Nos. 4,113,224, 4,197,266, and 4,347,198. Likewise, compression molding techniques where two mold halves are again brought together, but not necessarily brought into contact with one another, to define one or more molded surfaces, are well-known in the field of thermoplastic molding. Injection molding is another technique that may be adapted for use with the present semi-solid precursor materials of the present invention, where the semi-solid material can be rapidly forced into a cavity defined by two temperature-controlled mold halves, the material being optionally cured while in the mold, then being ejected from the mold halves with a subsequent shaping and or curing step if needed (if the semi-solid is not cured or only partially cured in the injection molding machine).

Such processes without curing or with only partial curing in the mold are suitable for the production of preforms, which can be later used in a static casting or compression molding process with curing to manufacture the final objects of interest. For the production of ophthalmic lenses, static casting, compression, and injection molding are all preferred processes because of their current prevalence in the art with either unreactive thermoplastic materials (injection and compression molding) or reactive precursors in a liquid state (static casting).

The process of the present invention is advantageous with respect to the conventional molding techniques because the semi-solid precursor materials provide a small but finite resistance to flow such that semi-solid does not flow out of the mold upon its introduction unlike liquid precursors used with static casting techniques. Yet, the semi-solid materials are compliant enough to be easily compressed and deformed to take on the desired mold cavity shape or surface features without undue resistance when two static compression molds are brought together. Furthermore, unlike typical thermoplastics, the semi-solid materials do not require an excessive or undesirable amount of heating and/or compressive force, typically seen with compression or injection molding techniques using conventional materials. Thus, the semi-solid materials of the present invention can be viewed as combining the easy deformability of liquids with the easy handling aspects of solids into a system that is reactive (but shows low shrinkage) and can be cured into a semi-IPN or a crosslinked gel upon cure.

Thus, in one embodiment, the semi-solid precursor materials provide a thermoplastic-like material that can be cured after molding to provide a crosslinked, thermosetting system, unlike conventional thermoplastics. When the semi-solid system is heavily plasticized with respect to the pure thermoplastics that make up the prepolymer, dead polymer, or the polymer that would result from the polymerization of the reactive plasticizers used in the semi-solid system, then the semi-solid will advantageously flow more easily and/or at lower temperatures than the corresponding thermoplastic material.

In another embodiment, the semi-solid precursor materials provide an improvement over liquid precursor material systems in that the semi-solids will not unduly flow out of the mold, can be cured rapidly and without the effects of oxygen inhibition, and exhibit little shrinkage upon cure with respect to the liquid precursor analogues.

Polymerization of the semi-solid precursor mixture in the mold assembly is preferably carried out by exposing the mixture to polymerization initiating conditions. The curing duration may often last minutes to days for parts that are thermally cured by heating slightly above ambient. Alternatively, when free-radical or cationic curing mechanisms are used and triggered by a high-intensity UV light source, the curing duration may last from a few minutes to less than a few seconds. The preferred technique is to expose a photoinitiator-containing composition to a source of ultraviolet (UV) radiation of an intensity and duration sufficient to initiate polymerization to the desired degree. Polymerization will generally occur even after the source of polymerizing energy, e.g., the UV light source, is removed, and the duration required to effectively complete polymerization to the desired degree can be determined without undue experimentation. When so desired, relatively intense UV light can be used in conjunction with the semi-solid precursor mixtures of this invention to achieve a sufficiently complete cure in a short time period without undue heat generation within the curing system. This advantage is especially pronounced when the semi-solid precursor mixture comprises only a prepolymer, and optionally one or more non-reactive diluents and/or a small amount (e.g., less than about 30 wt %, ore preferably less than about 20 wt %) of one or more reactive plasticizers.

A preferred embodiment of the process according to the present invention comprises the following steps:

a) introducing into the mold a semi-solid precursor material comprising a prepolymer and/or a reactive plasticizer, a photoinitiator, and optionally a dead polymer and/or a non-reactive diluent;

b) initiating the photocrosslinking reaction by a source of polymerizing energy such as UV light for a period of less than or equal to 1 minute; and

c) opening the mold, removing the cured molding, and placing the cured molding into a package for storage and/or shipping.

In another preferred embodiment, the semi-solid precursor mixture comprises a prepolymer and/or a dead polymer that are not water-soluble (i.e., do not dissolve in water at concentration ranges of 1-10 wt % in water), but are water-swellable after curing. Such compositions may be mixed with demulcent-type diluents, thereby eliminating the need for a separate extraction step after curing beyond that achieved in the demolding, handling, and packaging of the molding produced therefrom.

In a presently preferred embodiment, the semi-solid precursor mixture comprises a non-water-soluble but water-swellable prepolymer that is a functionalized copolymer of polyhydroxyethyl methacrylate (pHEMA). The copolymer can comprise methacrylic acid, acrylic acid, n-vinyl pyrrolidone, dimethyl acrylamide, vinyl alcohol, and other monomers along with HEMA. A presently preferred embodiment comprises PHEMA copolymerized with approximately 2% methacrylic acid. This copolymer is subsequently functionalized with methacrylate groups (or acrylate groups) to create a reactive prepolymer suitable for the production of ophthalmic moldings useful as contact lenses. The pHEMA-co-MAA copolymer is diluted with approximately 50 wt % of a 50:50 mixture (by weight) of 1,2propylene glycol and water, and a water-soluble photoinitiator such as ACVA is added at a concentration of 0.5 wt %. A 50:50 mixture of PEG400:water can be used in place of the propylene glycol:water mixture.

The material upon mixing becomes a clear and homogeneous semi-solid precursor mixture. Small portions of the semi-solid precursor mixture can be removed from the bulk mass and inserted into a mold cavity as a discrete quantity. Upon closing the mold, the semi-solid deforms and takes the shape of the internal cavity defined by the mold halves. When the sample is irradiated with a source of polymerizing energy such as UV light, the precursor mixture cures into a water-swellable crosslinked gel that can subsequently be demolded and placed into saline solution for equilibration. The gel can be designed to absorb approximately 30-70% water at equilibrium, while exhibiting mechanical properties such as elongation-to-break and modulus similar to commercially available contact lens materials. Thus, the molding so produced is useful as an ophthalmic lens, especially a contact or intraocular lens, said lens being produced with a semi-solid precursor material that exhibits low shrinkage during a rapid curing step, and said lens requiring no separate extraction step aside from the equilibration step in the package.

Another preferred embodiment uses hydrophilic silicones, which are copolymers of a hydrophilic component and a silicone component exhibiting high oxygen permeability, as the dead polymers, or when possessing additional function groups, as prepolymers or reactive plasticizers. Suitable silicone-based monomers and prepolymers for incorporation into the semi-solid precursor mixtures of the present invention are disclosed in U.S. Pat. Nos. 4,136,250, 4,153,641, 4,740,533, 5,010,141, 5,034,461, 5,057,578, 5,070,215, 5,314,960, 5,336,797, 5,356,797, 5,371,147, 5,387,632, 5,451,617, 5,486,579, 5,789,461, 5,807,944, 5,962,548, 5,998,498, 6,020,445, and 6,031,059, as well as PCT Appl. Nos. WO09415980, WO09722019, WO09960048, WO09960029, and WO00102881, and European Pat. Appl. Nos. EP00940447, EP00940693, EP00989418, and EP00990668.

Another preferred embodiment uses perfluoroalkyl polyethers, which are fluorinated to give good oxygen permeability and inertness, yet exhibit an acceptable degree of hydrophilicity due to the polymer back bone structure and/or hydrophilic pendant groups. Such materials may be readily incorporated into the semi-solid precursor mixtures of the present invention as the dead polymers, or when possessing additional function groups, as prepolymers or reactive plasticizers. For examples of such materials, see U.S. Pat. Nos. 5,965,631, 5,973,089, 6,060,530, 6,160,030, and 6,225,367.

### EXAMPLES

### Example 1

### General Method for the Preparation of Functionalized PolyHEMA

10 Grams of a poly(2-hydroxyethyl methacrylate) (polyHEMA, MW=300,000) were dissolved in anhydrous pyridine. To the solution 0.114 mL of methacrylate anhydride was added, and the mixture was continuously stirred for 12 to 24 hours. Pyridine was then removed under vacuum and the functionalized polyHEMA was precipitated twice in water to remove impurities. After drying, a polyHEMA with 1% functionality (theoretical value) was obtained, where 1% of the original pendant hydroxyl groups are modified to possess pendant methacrylate functionalities. For the PHEMA starting material used, this corresponds to about 20-25 pendant methacrylate groups per polymer chain.

PolyHEMAs with different degrees of functionality (ranging from 0.3% to 5%) have been prepared according to the procedure described above. Other degrees of functionality are easily prepared by adjusting the amount of methacrylate anhydride added to the pHEMA-pyridine mixture. Likewise, other reactive groups (e.g., acrylate, (meth)acrylamide, etc.) may be appended to the pHEMA chains using a similar approach.

### Example 2

### General Method for the Preparation of an Ophthalmic Molding from Functionalized PolyHEMA

Semi-solid materials for contact lens production have been prepared from functionalized pHEMA prepolymer and diluents that are compatible with the functionalized pHEMA (i.e., the diluents solvate pHEMA and form clear mixtures).

As an example, 0.06 g diluent and 0.002 g 1-hydroxycyclohexyl phenyl ketone (Irgacure 184) were added to 0.1 g of 1% functionalized pHEMA in a capped vial, and the material was left in an oven at 70° C. for 1 day. Typical diluents may comprise water, methanol, ethanol, isopropanol, propylene glycol, glycerol, and PEG (300, 400, . . . 1000, etc.) or mixtures of these. For this example, a 50:50 mixture by weight of ethanol and glycerol was used.

After one day at 70° C., the resulting material was a clear, relatively homogeneous semi-solid. An amount of the solvated material weighing 0.08 g was mixed by hand between two glass plates for about 2 minutes, and was then placed between two ophthalmic lens molds. The assembly was placed on a press at 50° C. with slight pressure to controllably bring the molds into contact with each other around their periphery (i.e., this approach mimics the static casting technique prevalently used in the contact lens industry). Excess semi-solid material was squeezed out of the mold as the two molds came together, and the amount of overflow was determined by the amount of material originally placed into the mold versus the mold cavity volume.

Once the molds were clamped together, the ophthalmic molding was cured for approximately 20 seconds under a Fusion UV light source using the V-bulb. It should be noted that shorter curing times are possible, and 20 seconds serves as an upper limit for the amount of time required to cure this particular molding composition and geometry. The mold assembly was then removed from the UV lamp, and the overflow material was trimmed from the edge of the lens molds. The lens molds were opened after allowing them to cool to room temperature, and an ophthalmic lens was thus obtained.

The ophthalmic lens of the present example contains an equilibrium water content of approximately 36-38% water, which depends on the degree of functionality of the starting prepolymer. Samples functionalized at about 0.5 to 1% exhibited mechanical moduli similar to those seen for commercially available contact lens materials having similar water contents, and were able to stretch to 2-4 times their original length before breaking.

### Example 3

### Moldings from 1% Functionalized PolyHEMA and Ophthalmic Demulcents

A mixture of 50 wt % functionalized pHEMA (1% methacrylate functionality, from Example 1), 25 wt % 1,2-propylene glycol (PPG), and 25 wt % water was homogenized in a capped vial in a 70° C. oven for 1 hour, during which time the sample became semi-solid in nature. The sample also contained 1 wt % (based upon the prepolymer and diluents) of the photoinitiator 4,4′-azobis(4-cyanovaleric acid). The semi-solid material was removed from the oven and was further mixed by hand for several minutes using two glass plates. Finally, the semi-solid precursor mixture was pressed out between the two glass plates to a thickness of approximately 100 microns, and was subsequently placed under a diffuse UV light source (Blak-Ray 100 AP, UVP, Inc.) for 20 minutes to cure. Note, sample cure times could be shortened significantly when more intense UV light sources are used.

Upon cure, the molding produced was removed from the molds and hydrated in water. The equilibrium water content was measured to be approximately 39%, and the sample had an elongation to break of approximately 200%. This sample is number 3a in Table 1 below.

Other semi-solid precursor mixtures were processed similarly, and the formulations and results are presented in the Table below (note, all samples were processed with 1% ACVA):

TABLE 1

| Sample | | | Water | |
|---|---|---|---|---|
| No. | Prepolymer | Diluents | Content | Elongation |
| 3a | 50% pHEMA (1%) | 25% PPG, | 39% | 200% |
| | | 25% water | | |
| 3b | 40% pHEMA (1%) | 30% PEG(400), | (not | (nm) |
| | | 30% water | measured) | |
| 3c | 60% pHEMA (1%) | 30% PPG, | 35% | 250% |
| | | 10% water | | |
| 3d | 60% pHEMA (1%) | 30% water, | (nm) | (nm) |
| | | 10% PPG | | |
| 3e | 48% pHEMA | 30% PPG, | 38% | 200% |
| | (1%), 12% | 10% water | | |
| | pHEMA (5%) | | | |
| 3f | 30% pHEMA | 30% PPG, | 36% | 100% |
| | (1%), 30% | 10% water | | |
| | pHEMA (5%) | | | |

### Example 4

### Moldings from Dead Polymers, Reactive Plasticizers, and Optionally, Non-reactive Diluents

Mixtures comprising dead polymers, one or more reactive plasticizers, a photoinitiator, and in some cases non-reactive diluents were homogenized in capped vials in a 70° C. oven for 24 hours, during which time the samples became semi-solid in nature. The semi-solid materials were removed from the oven and were further mixed by hand for several minutes using two glass plates. Finally, the semi-solid precursor mixtures were pressed out between the two glass plates to a thickness of approximately 100-500 microns, and were subsequently placed under a diffuse UV light source (Blak-Ray 100 AP, UVP, Inc.) for 10-20 minutes to cure. Note, sample cure times could be shortened significantly when more intense UV light sources were used.

Upon cure, the moldings produced were clear and gel-like, suitable for use as biomedical moldings. Example formulations are given in Table 2 below (all percentages are in wt %):

TABLE 2

| Sam- | | | | | Mold- |
|---|---|---|---|---|---|
| ple | Dead | Reactive | | | ing |
| No. | Polymer | Plasticizer(s) | Diluent(s) | Initiator | Result |
| 4a | 33% | 33% PEG-diacrylate | 33% | 0.5% | clear |
| | polyacry- | | ethylene | Irgacure | |
| | lic acid | | glycol | 1173 | |
| 4b | 50% | 25% PEG-diacrylate | 25% | 0.5% | clear |
| | pHEMA | | ethylene | Irgacure | |
| | | | glycol | 1173 | |
| 4c | 50% | 25% PEG-diacrylate | 25% | 0.5% | clear |
| | poly- | | ethylene | Irgacure | |
| | methyl | | glycol | 1173 | |
| | vinyl | | | | |
| | ether- | | | | |
| | co-maleic | | | | |
| | acid | | | | |
| 4d | 33% | 16% PEG-diacrylate, | 33% | 0.5% | clear |
| | carboxy | 16% polybutadiene | methanol | Irgacure | |
| | methyl | diacrylate | | 1173 | |
| | cellulose | | | | |
| 4e | 33% hy- | 16% PEG-diacrylate, | 33% | 0.5% | clear |
| | droxypro- | 16% polybutadiene | methanol | Irgacure | |
| | pyl methyl | diacrylate | | 1173 | |
| | cellulose | | | | |
| 4f | 29% | 25% acrylamide, 8% | 48% | 0.3% | clear |
| | poly(4- | methacrylated glucose | ethylene | Irgacure | |
| | vinyl | | glycol | 819 | |
| | pyridine) | | | | |
| 4g | 33% | 17% acrylamide, 6% | 44% | 0.3% | clear |
| | agarose | methacrylated glucose | ethylene | Irgacure | |
| | | | glycol | 819 | |
| 4h | 50% | 13% acrylamide, 4% | 33% | 0.3% | clear |
| | carboxy- | methacrylated glucose | ethylene | Irgacure | |
| | methyl | | glycol | 819 | |
| | cellulose | | | | |
| 4i | 31% | 2% tetraethylene | 67% | 0.5% | clear |
| | pHEMA | glycol | ethanol | Darocur | |
| | | dimethacrylate | | 1173 | |
| 4j | 53% | 14% | 33% | 0.5% | clear |
| | pHEMA | trimethylolpropane | ethylene | Irgacure | |
| | | trimethacrylate | glycol | 819 | |

What is claimed is:

1. A polymeric precursor mixture which comprises:
(a) a first component selected from one or more of the group consisting of prepolymers and dead polymers; and
(b) optionally, a second component selected from one or more of the group consisting of reactive plasticizers and non-reactive diluents;
provided that at least one reactive plasticizer is present when a prepolymer is not present.

2. A polymeric precursor mixture according to claim 1 which is a semi-solid.

3. A polymeric precursor mixture according to claim 1 wherein the first component consists of one or more prepolymers and the second component consists of one or more non-reactive diluents selected from the group consisting of water, ophthalmic demulcents, and mixtures thereof.

4. A polymeric precursor mixture according to claim 3 which is a semi-solid.

5. A polymeric precursor mixture according to claim 1 wherein the first component is non-water-soluble.

6. A polymeric precursor mixture according to claim 2 wherein the first component is non-water-soluble.

7. A polymeric precursor mixture according to claim 2 wherein the prepolymer or dead polymer comprises a majority of 2-hydroxyethyl methacrylate monomer units.

8. A polymeric precursor mixture according to claim 2 wherein said prepolymer is a hydrophilic silicone.

9. A molding made from a semi-solid polymeric precursor mixture comprising a first component selected from one or more of the group consisting of prepolymers and dead polymers; and optionally, a second component selected from one or more of the group consisting of reactive plasticizers and non-reactive diluents; provided that at least one reactive plasticizer is present when a prepolymer is not present;.

10. A molding according to claim 9 which exhibits minimal expansion or contraction upon equilibration in a physiologically acceptable saline solution.

11. A molding according to claim 9 which does not require a separate extraction step prior to its intended use.

12. An molding according to claim 9 wherein the polymeric precursor mixture exhibits low shrinkage upon cure.

13. A molding according to claim 9 wherein the prepolymer or dead polymer comprises a majority of 2-hydroxyethyl methacrylate monomer units.

14. A molding according to claim 9 which is water-swellable.

15. A molding according to claim 9 which is a contact lens or an intraocular lens.

16. A method for preparing a molding comprising:
mixing together an initiator and a polymeric precursor mixture comprising a first component selected from one or more of the group consisting of prepolymers and dead polymers; and optionally, a second component selected from one or more of the group consisting of reactive plasticizers and non-reactive diluents; provided that at least one reactive plasticizer is present when a prepolymer is not present; to form a semi-solid composition;
providing a mold corresponding to a desired geometry;
introducing said semi-solid composition into said mold;
compressing said mold so that the semi-solid composition takes on the shape of the internal cavity of said mold; and
exposing said semi-solid composition to a source of polymerizing energy; to give a cured molding.

17. A method according to claim 16 wherein the cured molding exhibits minimal expansion or contraction.

18. A method according to claim 16 which further comprises the step of providing a waiting period at a predetermined temperature after the semi-solid composition is compressed in the mold and before exposing to the source of polymerizing energy.

19. A method according to claim 16 which further comprises the step of placing the cured molding into a package containing a saline solution.

20. A method according to claim 16 wherein the mold may be reused.

21. A method according to claim 16 wherein the first component consists of one or more prepolymers and the second component consists of one or more non-reactive diluents selected from the group consisting of water, ophthalmic demulcents, and mixtures thereof.

22. A method according to claim 16 wherein the first component is non-water-soluble.

23. A method according to claim 16 wherein the semi-solid composition is exposed to a source of polymerizing energy for a quick curing time.

24. A method according to claim 16 wherein the cured molding requires only a minimal extraction step prior to its intended use.

25. A method according to claim 16 wherein the semi-solid composition exhibits low shrinkage upon cure.

26. A method according to claim 16 wherein the semi-solid composition comprises a prepolymer or dead polymer having a majority of 2-hydroxyethyl methacrylate monomer units.
